(19) United States
(12) Patent Application Publication
(10) Pub. No.: US 2015/0228014 A1
(43) Pub. Date: Aug. 13, 2015

(54) AUTOMATED CUSTOMER CHARACTERIZATION

(71) Applicant: BANK OF AMERICA CORPORATION, Charlotte, NC (US)

(72) Inventors: Adam Burgess, Matthews, NC (US); Fred Armstrong, Davidson, NC (US); Carly Bradbury, Philadelphia, PA (US); Matthew Cappio, Arlington, VA (US); Amy L. Clark, Charlotte, NC (US); Kristen Conly, Wilmington, DE (US); Nenping Ruan, Wilmington, DE (US); Tom Smith, Charlotte, NC (US); Joseph Zeibert, Charlotte, NC (US)

(21) Appl. No.: 14/590,793

(22) Filed: Jan. 6, 2015

Related U.S. Application Data
(63) Continuation of application No. 12/827,567, filed on Jun. 30, 2010, now abandoned.

(51) Int. Cl. G06Q 40/02; G06Q 30/02

(52) U.S. Cl. CPC G06Q 40/02; G06Q 30/0204

(57) ABSTRACT

A comprehensive and holistic behavior-based customer characterization scheme is presented. Specifically, the characterization scheme includes internal credit behavior segmentation and external credit segmentation. In other embodiments, the characterization includes internal credit behavior segmentation and external credit segmentation, and spend preference segmentation. In still further embodiments any combination of behavior algorithms may be implemented to characterize the customer base and determine a related customer profile. The application additionally provides for new behavior algorithms to be added as needed in the future and the ability to interface with existing/legacy segmentation applications.

### FIELD

In general, embodiments of the invention relate to systems, apparatus and computer program products for understanding customer behaviors and, more particularly, for automatically characterizing an entire customer base according to a plurality of customer behaviors.

### BACKGROUND

In many businesses it is important to understand their customers in terms of who they are and what behaviors they exhibit. Understanding customers and customer's behaviors provides the business with the information needed to better service the customers, specifically, the types of products and/or services offered to the client and terms/pricing associated with such products and services. This type of customer knowledge is especially advantageous in the financial institution (e.g., banks, lending companies, investment companies and the like) industry, in which the products/services offered are diverse, the terms and pricing vary according to customer information and customer behaviors tend to provide an insight into the potential for providing additional products and/or services.

Currently many businesses and, in particular financial institutions, implement various segmentation tools to segment or group products, services and/or customers. However, in the financial institution realm, the vast majority of such segmentation tools are product or service specific. For example, in the financial institution sector, many of the segmentation tools are limited to credit card accounts or the like. As such, these tools are limited to rendering information on the accounts, such as whether the account is a transacting account (i.e., balance paid in full on monthly basis), a revolving account (i.e., balance fluctuates over time), or an inactive account. As such, many of the segmentation tools in the financial institution industry fail to provide a link between the customer and the product/service.

In instances in which segmentation tools provide some degree of customer behavioral information, the various segmentation tools tend to provide a wide range of results in terms of their views of the customer and, in some instances, conflicting results. This is because the various tools address different or disparate business needs. For example, some of the tools are limited to specific products/services and do not leverage customer information beyond those specific products. In other instances, the customer behaviors that are implemented in the segmentation process are limited to internal financial institution activity and do not leverage external financial institution activity.

Therefore, a need exists to develop a comprehensive customer segmentation tool for the financial institution industry. The comprehensive tool should not be limited to specific products, services and/or accounts within a financial institution but rather should encompass multiple, if not all, products, services and/or accounts that the customer has active within the financial institution. Moreover, the desired customer segmentation tool should include customer behavioral information, such as spending preferences, payment preferences, credit account activity preferences and the like. In addition, the desired customer segmentation tool should leverage data from external financial institutions for the purpose of gaining a complete financial behavior picture of the customer. In addition, the desired customer segmentation tool should take into account customer behaviors that have either not previously been considered or have been considered only in limited applications.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for comprehensive behavior-based customer segmentation and profiling application. The customer segmentation and profiling application herein disclosed is not limited to a specific product, service or account but rather takes into account multiple, and in some embodiments all, products, services or accounts associated with the customer. In addition, the customer segmentation tool of the present invention is not limited to internal business behavioral information but encompasses external business behavior as well. For example, in the financial institution sector, the customer segmentation application not only relies on behavioral information related to internal financial institution products, services and accounts, but also benefits from external financial institution (i.e., other financial institutions that the customer has a relationship with) in assessing customer behavior.

In other embodiments of the invention, the customer segmentation tool has the capability to assess and segment customers based on other customer behaviors, such as, spend preferences, debt trends, rewards program behaviors, risk, profitability and the like. In addition, the comprehensive nature of the customer segmentation application provides for additional segmentation criteria to be identified and implemented in the future as it is recognized or otherwise evolves and, as such, is expandable to adapt to new business needs. In addition, the customer segmentation and profiling application herein described provides for the ability to interface with existing/legacy segmentation applications to determine customer segments.

An apparatus for segmenting a financial institution customer base based on behaviors provides for first embodiments of the invention. The apparatus includes a computing device including a memory and at least one processor. The apparatus further includes a customer segmentation application stored in the memory, executable by the processor and configured to determine customer segments defined by customer's having same customer profiles. The application includes an internal credit behavior algorithm configured to determine, for each of a plurality of financial institution customers, an internal credit behavior segment associated with one or more internal credit accounts. The application further includes an external credit behavior algorithm configured to determine, for each of a plurality of financial institution customers, an external credit behavior segment associated with one or more external financial institutions and one or more credit accounts at the one or more external financial institutions. In addition, the application includes a customer profile algorithm configured to determine a customer profile for each of the plurality of financial institution customers based on the internal credit behavior segment and the external credit behavior segment.

In specific embodiments of the apparatus the customer segmentation application also includes a spend preference behavior algorithm configured to determine, for each of a plurality of financial institution customers, a spend preference behavior segment. In such embodiments, the customer profile algorithm is further configured to determine the customer profile based on the internal credit behavior segment, the external credit behavior segment and the spend preference behavior segment.

In related embodiments of the apparatus, the spend preference behavior algorithm is further configured to determine a first payment type having a highest volume of transactions over a predetermined time period and determine a second payment type having a highest transaction amount over the predetermined time period. Further, in such embodiments the spend preference behavior algorithm may be further configured to assign the spend preference behavior segment as a payment type if the first and second payment types are the same. Alternatively, the spend preference behavior algorithm may be further configured to assign the spend preference behavior segment as a mixed value if the first and second payment types are different payment types.

In further specific embodiments of the apparatus, the internal credit behavior algorithm is further configured to determine the internal credit behavior segment as one of revolver credit, transactor credit, inactive credit or missing credit and the external credit behavior algorithm is further configured to determine the external credit behavior segment as one of revolver credit, transactor credit, inactive credit or missing credit. In still further specific embodiments of the apparatus, the internal credit behavior algorithm is further configured to determine the internal credit behavior segment as a predefined predominate credit behavior from amongst the plurality of credit accounts and the external credit behavior algorithm is further configured to determine the external credit behavior as a predefined predominate credit behavior from amongst the one or more credit accounts at the one or more external financial institutions. In such embodiments, the predefined predominate credit behavior may be defined as (1) revolver credit if a revolving balance exists across any of the one or more credit accounts, (2) transactor credit if revolving balance does not exist across any of the one or more credit accounts and one or more of the accounts is active, (3) inactive credit if an account exists and not revolver credit or transactor credit, (4) missing credit if there is no active or inactive account present.

In further specific embodiments of the apparatus, the customer segmentation application includes a debt trend behavior algorithm configured to determine, for each of a plurality of financial institution customers, a debt trend behavior segment. In such embodiments, customer profile algorithm is further configured to determine the customer profile based on the internal credit behavior segment, the external credit behavior segment and the debt trend segment. In related embodiments, the debt trend behavior algorithm is further configured to determine the debt trend behavior segment, such that, the debt trend is the combined internal and external debt trend. In addition, in further related embodiments, the debt trend behavior algorithm is further configured to determine the debt trend behavior segment, such that, the debt trend segment is one of increasing debt trend, decreasing debt trend, stable debt trend zero debt or the absence of debt altogether.

In further specific embodiments of the apparatus, the customer segmentation application includes a debt wallet share behavior algorithm configured to determine, for each of the plurality of financial institution customers, a debt wallet share behavior segment. In related embodiments, the debt wallet share behavior algorithm is further configured to determine the wallet share behavior segment, such that, the wallet share behavior segment is the share of the combined internal and external debt that the internal debt alone composes. In addition, in further related embodiments, the debt wallet share behavior algorithm is further configured to determine the wallet share behavior segment, such that, the wallet share segment is one of zero wallet share, between zero and twenty-five percent wallet share, between twenty-five percent and fifty percent wallet share, between fifty percent and seventy-five percent wallet share, and between seventy-five and one hundred percent wallet share.

In still further specific embodiments of the apparatus, the customer segmentation application includes a profitability behavior algorithm configured to determine, for each of a plurality of financial institution customers, a profitability behavior segment associated with one or more financial accounts or financial services. In such embodiments, the customer profile algorithm is further configured to determine the customer profile based on the internal credit behavior segment, the external credit behavior segment and the profitability behavior segment. In related embodiments, the profitability behavior algorithm is further configured to determine the profitability behavior segment, such that, the profitability behavior segment is one of high profitability, intermediate profitability or negative profitability.

In additional specific embodiments of the apparatus, the customer segmentation application includes a rewards behavior segment configured to determine, for each of a plurality of financial institution customers, a rewards behavior segment associated with one or more financial accounts or financial services. In such embodiments, the customer profile algorithm is further configured to determine the customer profile based on the internal credit behavior segment, the external credit behavior segment and the rewards behavior segment. In related embodiments, the rewards behavior algorithm is further configured to determine the rewards behavior segment associated with one of rewards preferences, frequency of rewards or average redemption amounts.

Moreover, in other specific embodiments, the customer segmentation application includes a risk behavior algorithm configured to determine, for each of a plurality of financial institution customers, a risk behavior segment and wherein the customer profile algorithm is further configured to determine the customer profile based on the internal credit behavior segment, the external credit behavior segment and the risk behavior segment.

A method for segmenting a plurality of financial institution customers based on behaviors defines second embodiments of the invention. The method includes determining, via a computing device processor, for a plurality of financial institution customers, an internal credit behavior segment associated with one or more credit accounts and an external credit behavior segment associated with one or more external financial institutions and one or more credit accounts at the one or more external financial institutions. The method further includes determining, via a computing device processor, a customer profile for each of the plurality of financial institution customers based on the internal credit behavior segment and the external credit behavior segment, wherein customers having a same customer profile define a customer segment.

In specific embodiments the method includes determining, via a computing device processor, for the plurality of financial customers, a spend preference behavior segment. In such embodiments, determining the customer profile further includes determining, via a computing device processor, a customer profile for each of the plurality of financial institution customers based on the internal credit behavior segment, the external credit behavior segment and the spend preference behavior segment.

In further such embodiments, determining the spend preference behavior segment includes determining a first payment type having the highest volume of transactions over a predetermined time period and determining a second payment type having the highest transaction amount over the predetermined time period. In such embodiments, determining the spend preference behavior segment further includes assigning the spend preference behavior segment as a payment type if the first and second payment types are the same payment type. Alternatively, assigning the spend preference behavior segment as mixed value if the first and second payment types are different payment types.

In other specific embodiments of the method, determining the internal credit behavior segment and determining the external credit behavior further includes determining the internal credit behavior segment, wherein the internal credit behavior segment is one of revolver credit, transactor credit, inactive credit or missing credit and determining the external credit behavior segment, wherein the external credit behavior segment is one of revolver credit, transactor credit, inactive credit or missing credit. In further specific embodiments determining the internal credit behavior segment and determining the external credit behavior segment further include determining the internal credit behavior segment is a predefined predominate credit behavior from amongst the plurality of credit accounts and determining the external credit behavior segment, wherein the external credit behavior segment is a predefined predominate credit behavior from amongst the one or more credit accounts at the one or more external financial institutions. In specific embodiments the predefined predominated credit behavior is defined as (1) revolver credit if a revolving balance exists across any of the one or more credit accounts, (2) transactor credit if revolving balance does not exist across any of the one or more credit accounts and one or more of the accounts is active, (3) inactive credit if credit account(s) exist and not revolver credit or transactor credit, (4) missing credit if there is no active or inactive credit account present.

Further specific embodiments of the method include determining, via a computing device processor, for the plurality of financial institution customers, a debt trend behavior segment. In such embodiments, determining the customer profile further includes determining, via a computing device processor, a customer profile for each of the plurality of financial institution customers based on the internal credit behavior segment, the external credit behavior segment and the debt trend segment. In further related embodiments, the debt trend is a combined internal financial institution and external financial institution debt trend. In still further related embodiments, the debt trend segment is one of increasing debt trend, decreasing debt trend, stable debt trend, zero debt or the absence of debt altogether.

Further specific embodiments of the method include determining, via a computing device processor, for the plurality of financial institution customers, a debt wallet share behavior segment. In further related embodiments, the debt wallet share behavior routine is further configured to determine the wallet share behavior segment, such that, the wallet share behavior segment is the share of the combined internal and external debt that the internal debt alone composes. In addition, in further related embodiments, the wallet share behavior routine is further configured to determine the wallet share behavior segment, such that, the wallet share segment is one of zero wallet share, between zero and twenty-five percent wallet share, between twenty-five percent and fifty percent wallet share, between fifty percent and seventy-five percent wallet share, and between seventy-five and one hundred percent wallet share.

In other specific embodiments the method includes determining, via a computing processor, for the plurality of financial institution customers, a profitability behavior segment associated with one or more financial accounts or financial services, In such embodiments, determining the customer profile further includes determining, via a computing device processor, a customer profile for each of the plurality of financial institution customers based on the internal credit behavior segment, the external credit behavior segment and the profitability behavior segment. In related embodiments, the profitability behavior segment may be associated with one customer account or may be financial institution wide. In other related embodiments, the profitability behavior segment is one of high profitability, intermediate profitability or negative profitability.

In yet other specific embodiments the method includes determining, via a computing device processor, for the plurality of financial institution customers, a rewards behavior segment associated with one or more financial accounts or financial services. In such embodiments, determining the customer profile further includes determining, via a computing device processor, a customer profile for each of the plurality of financial institution customers based on the internal credit behavior segment, the external credit behavior segment and the rewards behavior segment.

In still further specific embodiments the method includes determining, via a computing device processor, for the plurality of financial institution customers, a rewards behavior segment associated with one or more financial accounts or financial services. In such embodiments, determining the customer profile further includes determining, via a computing device processor, a customer profile for each of the plurality of financial institution customers based on the internal credit behavior segment, the external credit behavior segment and the rewards behavior segment. In related embodiments, the rewards behavior segment is associated with one of rewards preferences, frequency of rewards or average redemption amounts.

Moreover, in further specific embodiments the method includes determining, via a computing device processor, for the plurality of financial institution customers, a risk behavior segment associated with a financial institution customer. In such embodiments, determining the customer profile further includes determining, via a computing device processor, a customer profile for each of the plurality of financial institution customers based on the internal credit behavior segment, the external credit behavior segment and the risk behavior segment.

A computer program product including a non-transitory computer-readable medium defines third embodiments of the invention. The computer-readable medium includes a first set of codes for causing a computer to determine, for a plurality of financial institution customers, an internal credit behavior segment associated with one or more credit accounts. Additionally, the computer-readable medium includes a second set of codes for causing a computer to determine, for the plurality of financial institution customers, an external credit behavior segment associated with one or more external financial institutions and one or more credit accounts at the one or more external financial institutions. In addition, the computer-readable medium includes a third set of codes for causing a computer to determine a customer profile for each of the plurality of financial institution customers based on the internal credit behavior segment and the external credit behavior segment, wherein customers having a same customer profile define a customer segment.

An apparatus for determining a spend preference behavior segment for a customer base provides for fourth embodiments of the invention. The apparatus includes a computing device including a memory and at least one processor. The apparatus further includes a spend preference behavior algorithm stored in the memory and executable by the processor. The spend preference algorithm is configured to determine a first payment type having a highest volume of transactions over a predetermined time period and determine a second payment type having a highest transaction amount over the predetermined time period. The algorithm is further configured to assign the spend preference behavior segment as a payment type if the respective first and second financial accounts are same payment type and assign the spend preference behavior segment as a mixed value if the first and second payment types are different payment type.

A method for determining a spend preference behavior segment for a customer base defines fifth embodiments of the invention. The method includes determining, via the computing device processor, for each of a plurality of financial institution customers, a first payment type having a highest volume of transactions over a predetermined time period. The method further includes determining, via the computing device processor, for each of a plurality of financial institution customers, a second payment type having a highest transaction amount over the predetermined time period. Additionally, the method includes assigning, via the computing device processor, for each of the plurality of financial institution customers, the spend preference behavior segment as a payment type if the respective first and second payment types are same payment type. In addition, the method includes assigning, via the computing device processor, for each of the plurality of financial institution customers, the spend preference behavior segment as a mixed value if the first and second payment types are different payment types.

Thus, further details are provided below for systems, apparatus, methods and computer program products for comprehensive and holistic behavior-based customer segmentation and customer profiling. In specific embodiments of the invention, the segmentation includes internal credit behavior segmentation, external credit segmentation and, in some embodiments, spend preference segmentation. In still further embodiments any combination of behavior algorithms may be implemented to segment the customer base and determine a related customer profile. The application additionally provides for new behavior algorithms to be added as needed in the future and the ability to interface with existing/legacy segmentation applications.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is schematic diagram of an apparatus configured to provide behavior-based customer segmentation and profiling, in accordance with embodiments of the present invention;

FIG. 2 is another schematic diagram of an apparatus configured to provide behavior-based customer segmentation and profiling, in accordance with embodiments of the present invention;

FIG. 3 is a schematic block diagram of a customer segmentation application including multiple behavior-based segmentation algorithms, in accordance with embodiments of the present invention;

FIG. 4 is a schematic diagram of a more detailed apparatus configured to provide behavior-based customer segmentation and profiling, in accordance with embodiments of the present invention;

FIG. 5 is a flow diagram of a method for determining internal credit behavior segments, in accordance with embodiments of the present invention;

FIG. 6 is a flow diagram of a method for determining external credit behavior segments, in accordance with embodiments of the present invention;

FIG. 7 is a flow diagram of a method for determining spend preference behavior segments, in accordance with embodiments of the invention;

FIG. 8 is a flow diagram of a method for determining debt trend behavior segments, in accordance with embodiments of the present invention; and

FIG. 9 is a flow diagram of a method for behavior-based customer segmentation and profiling, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

As may be appreciated by one of skill in the art, the present invention may be embodied as a method, system, computer program product, or a combination of the foregoing. Accordingly, the present invention may take the form of an entirely software embodiment (including firmware, resident software, micro-code, etc.) or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, infrared, or semiconductor system, apparatus, device, or propagation medium. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device; or transmission media such as those supporting the Internet or an intranet. Note that the computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

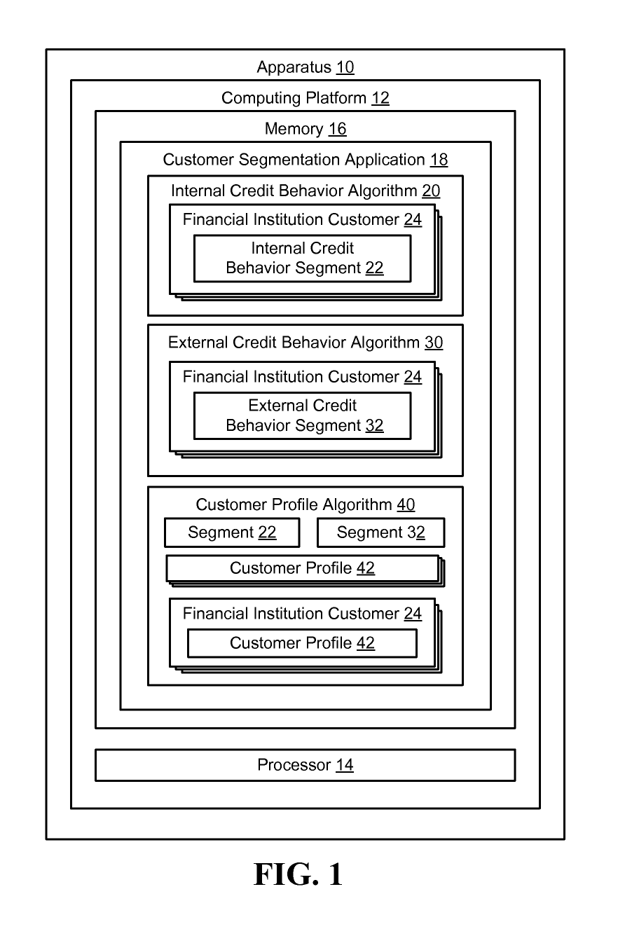

Thus, apparatus, systems, methods and computer program products are herein disclosed that provide comprehensive behavior-based customer segmentation and profiling. FIG. 1 provides a high level schematic diagram of an apparatus 10 configured for behavior-based customer segmentation and customer profiling, in accordance with embodiments of the present invention. More specifically, the embodiments disclosed in relation to FIG. 1 provide for customer segmentation and subsequent customer profiling based on internal and external financial institution credit behavior. The apparatus 10 includes a computing platform 12 having at least one processor 14 and a memory 16.

The memory 16 of apparatus 10 stores customer segmentation application 18 that is configured to determine financial institution customer profiles and/or customer segments based at least in part on the customers' internal financial institution credit behavior and the customers' external financial institution credit behavior, in accordance with embodiments of the present invention. Thus, customer segmentation application 18 includes internal credit behavior algorithm 20 that is configured to determine, for a plurality of financial institution customers 24, an internal credit behavior segment 22 that is associated with one or more internal credit accounts. In some, embodiments of the invention, the plurality of financial institution customers 24 are all of the customers within a financial institution, while in other embodiments the plurality may be a portion of the overall customer base, for example, all of the consumer customers or all of the business customers. The internal financial institution is defined herein as the financial institution implementing the customer segmentation application 18. Thus, the internal financial institution may comprise multiple branches, divisions, subsidiaries and the like.

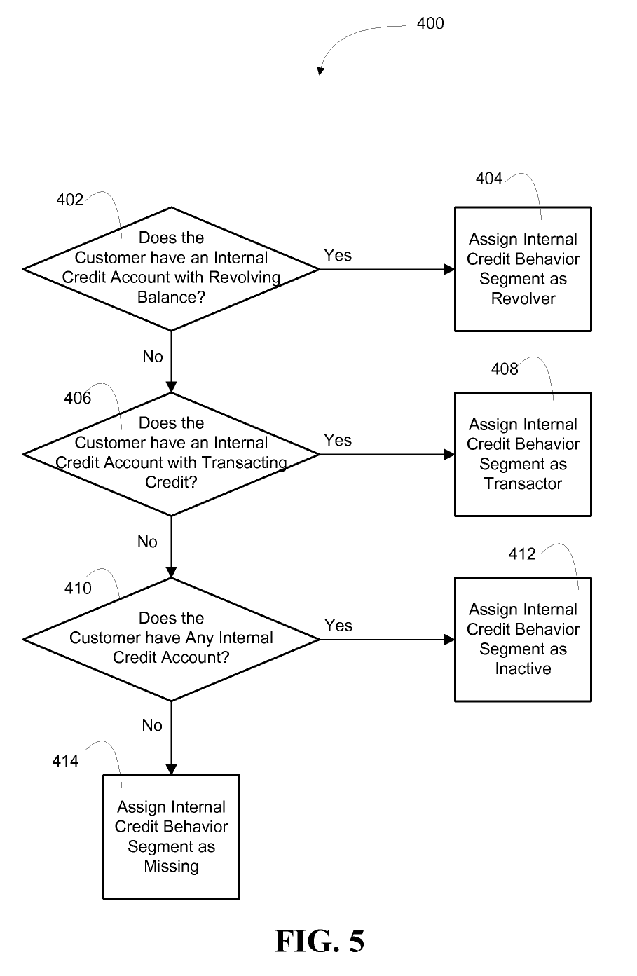

The internal credit behavior segment 22 may be any one of a plurality of user defined segments that classify the customer according to their internal credit behavior. As noted the internal credit behavior segment 22 may be associated with more than one internal credit account and, in most instances all of the credit accounts that the customer currently has with the financial institution. Thus, if the customer currently has three credit accounts; two credit card accounts and a home equity credit account, the internal credit behavior segment may indicate the behavior across all three accounts. In one specific embodiment of the invention the internal credit behavior segment 22 may be one of four segments, specifically, revolver, transactor, inactive and missing. The revolver segment indicates that the customer has at least one internal credit account with revolving credit, i.e., carries a balance from payment period-to-payment period and, thus, accrues credit. The transactor segment indicates that the customer pays all of their internal credit account balances in full each payment period. The inactive segment indicates that the customer does not currently have any open internal credit accounts or any active internal credit accounts. The missing segment indicates that the customer does not currently have any internal, and in some embodiments external, credit accounts. FIG. 5, discussed infra. provides further details related to this embodiment of the invention. It should be noted that in other embodiments of the invention more or less internal credit behavior segments 22 may be implemented and such segments may classify internal credit behavior based on the financial institutions profiling/segmentation needs.

Customer segmentation application 18 additionally includes external credit behavior algorithm 30 that is configured to determine, for a plurality of financial institution customers 24, an external credit behavior segment 32 that is associated with one or more external financial institutions and one or more credit accounts at each of the financial institutions. An external financial institution is defined herein as any other financial institution other than the financial institution implementing the customer profile and segmentation application 18.

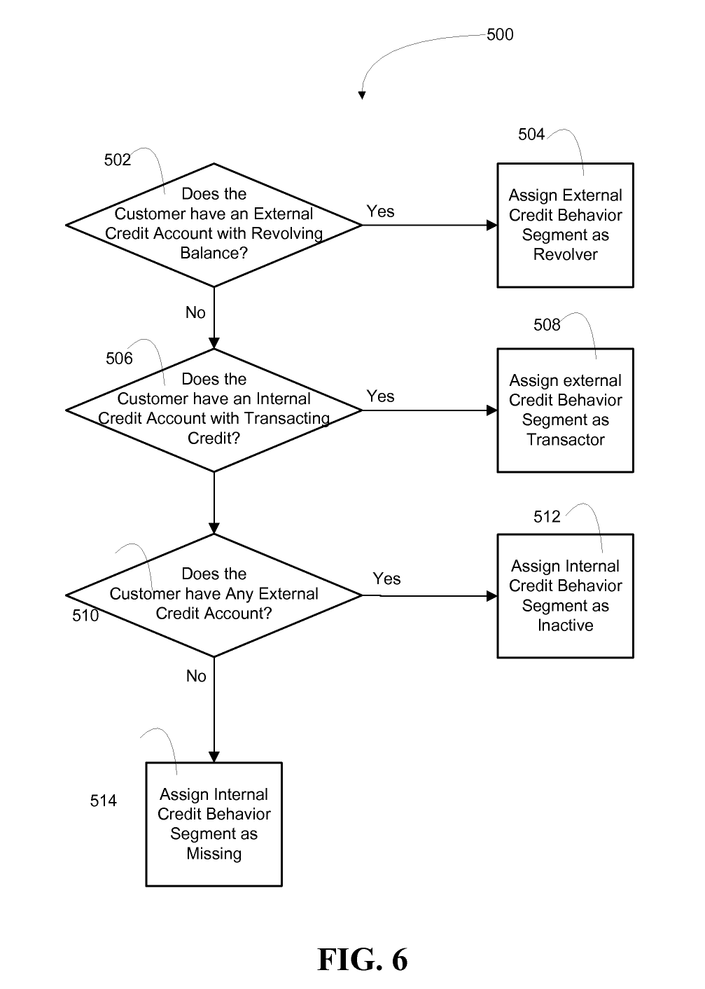

The external credit behavior segment 32 may be any one of a plurality of user defined segments that classify the customer according to their external credit behavior. In one specific embodiment of the invention the external credit behavior segment 32 may include one of three segments, specifically, revolver, transactor, inactive and missing. The revolver segment indicates that the customer has at least one external credit account with revolving credit, i.e., carries a balance from payment period-to-payment period and, thus, accrues credit. The transactor segment indicates that the customer pays all of their external credit account balances in full each payment period, the inactive segment indicates that the customer does not currently have any open external credit accounts, or the missing segment indicates that the customer is unaccounted for within third party databases, e.g., credit bureaus or the like, or insufficient data exists. FIG. 6, discussed infra. provides further details related to this embodiment of the invention. It should be noted that in other embodiments of the invention more or less external credit behavior segments 32 may be implemented and such segments may classify internal credit behavior based on the financial institutions profiling/segmentation needs.

Customer segmentation application 18 additionally includes customer profile algorithm 40 that is configured to determine a customer profile 42 for each of the plurality of customers based on the internal credit behavior segment and the external credit behavior segment. A customer profile is defined by one or more combinations of the determined behavior segments. In the embodiment described above, in which three internal credit behavior segments (i.e., revolver, transactor, inactive) are implemented and three external credit behavior segments (i.e., revolver, transactor, inactive) are implemented, the resulting number of customer populations may be nine (three×three). Thus, the customer populations may provide for nine customer profiles 42 or in stances in which a lesser number of profiles are needed, customer populations may be grouped together to form a customer profile 42.

As described in subsequent embodiments of the invention, when more behavior segments are implemented by the customer segmentation application 18 more customer populations will result. For example, in the embodiment in which one hundred or more customer populations exist, the customer populations may be combined to make up a customer profile profiles 42 based on the user's needs, such as marketing needs, reporting needs, or other classification needs. Thus, for example, the one hundred or more customer populations may be pared down to, for example, to ten customer profiles 42, with each customer profile comprising one or more customer populations. It should be noted that the number of customer populations comprising a customer profile 42 may not be equivalent from profile-to-profile and may vary based on the customer's classification of a customer population and/or needs.

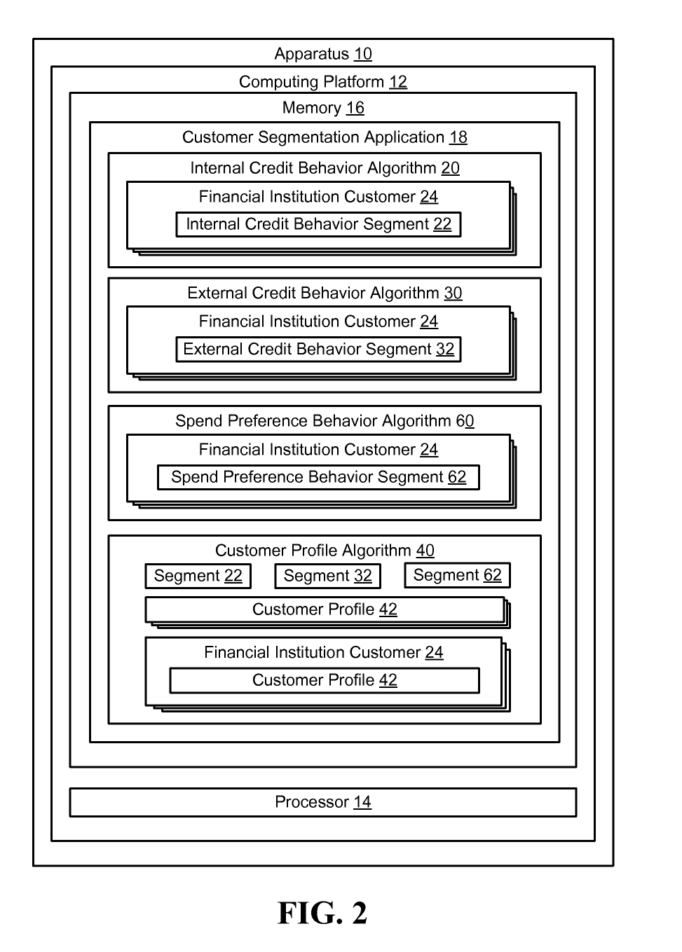

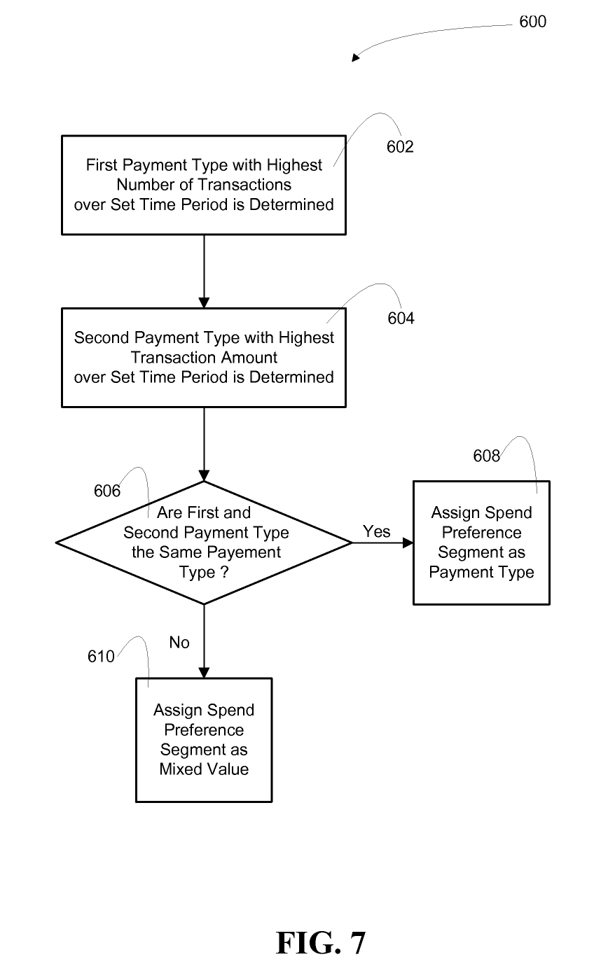

Referring to FIG. 2 an alternate embodiment of the invention is depicted, in which, apparatus 10 is configured for customer profiling and/or segmentation based on internal and external financial institution credit behavior and spending preference behavior. Thus, in addition to internal credit behavior algorithm 20 and external credit behavior algorithm 30, the customer segmentation application 18 includes spending preference behavior algorithm 60 that is configured to determine, for a plurality of financial institution customers 24, a spending preference segment 62 The spending preference segment 62 may be any one of a plurality of user defined segments that classifies the customer according to their preferred payment type, such as a financial account or financial product. The payment type may include, but is not limited to, a credit card, a debit card, checks, cash, online/mobile bill pay and the like. The spending preference behavior algorithm 60 may be configured to determine the spend preference segment 62 based solely on internal financial institution accounts/products or, in other embodiments, the spend preference algorithm may determine the spend preference segment based on both internal financial institution accounts/products and external financial institution accounts/products. FIG. 7, discussed infra. provides further details related to a specific process for determining spend preference, according to embodiments of the invention.

In such embodiments, the customer profile algorithm 40 is configured to determine a customer profile 42 for each of the plurality of customers based on the internal credit behavior segment, the external credit behavior segment and the spend preference segment. As previously noted, the customer profile 42 is defined by the combination of the determined behavior segments. For example, in an embodiment in which four internal credit behavior segments (i.e., revolver, transactor, inactive, missing) are implemented, four external credit behavior segments (i.e., revolver, transactor, inactive, missing) are implemented, and seven spend preference segments are implemented (i.e., credit card, debit, checks, cash, online/mobile bill pay, mixed value and missing), the resulting number of customer populations is one-hundred twelve (four×four×seven). The one-hundred twelve customer populations may be included within a lesser number of customer profiles 42, for example, in one embodiment the one-hundred twelve customer populations may be pared down to twelve customer profiles 42 or the like.

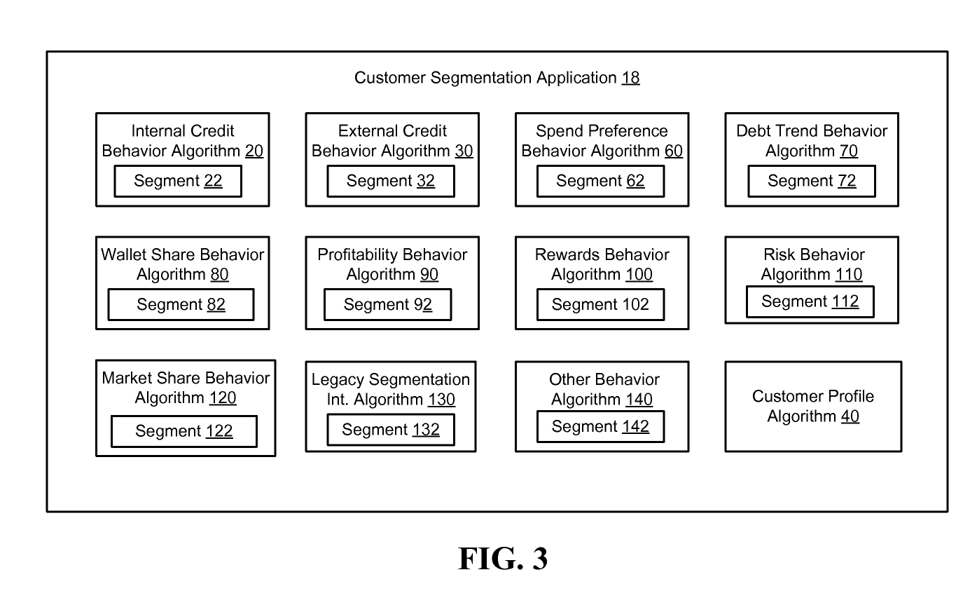

Referring to FIG. 3 a comprehensive customer segment application 18 is depicted that includes multiple behavior algorithms, in accordance with an embodiment of the present invention. It should be noted that any combination of behavior segments resulting from the multiple behavior algorithms may be used to determine a customer profile 42 and/or a customer segment 52 depending on the needs of the financial institution implementing the application.

As previously described, the customer segment application 18 may include internal credit behavior algorithm 20, external credit behavior 30 and spend preference behavior algorithm 60. Additionally, the customer segmentation application 18 may include debt trend behavior algorithm 70, wallet share behavior algorithm 80, profitability behavior algorithm 90, rewards behavior algorithm 100, risk behavior algorithm 110, market share behavior algorithm 120, legacy segmentation interface algorithm 130 and other/further behavior algorithm 140.

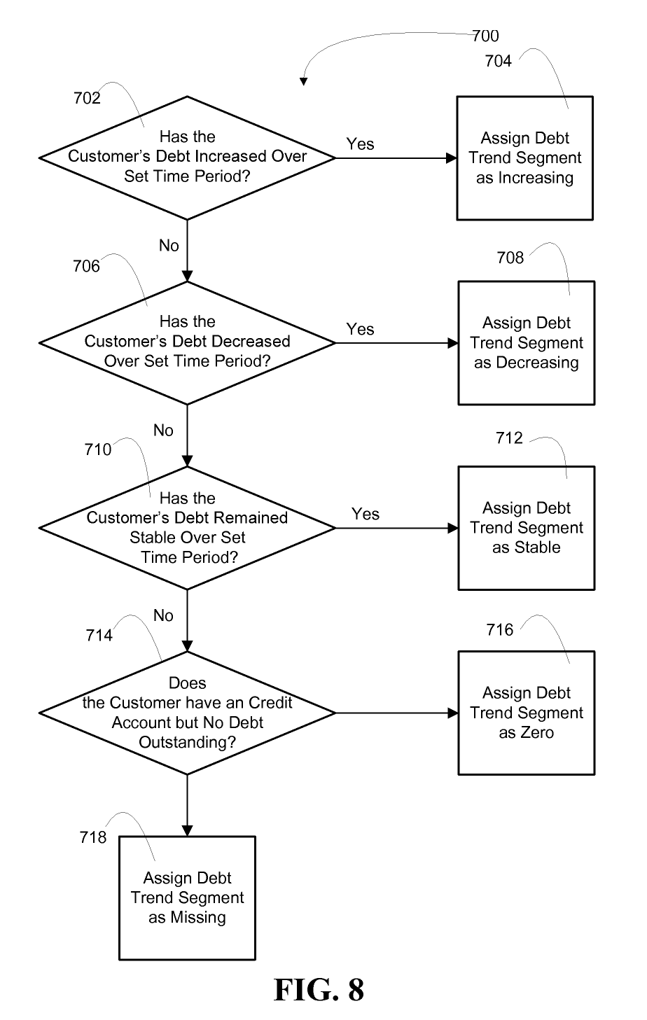

Debt trend behavior algorithm 70 is configured to determine, for the plurality of financial institution customers, a debt trend segment 72 that indicates the trend status of the customer's debt. The debt trend behavior algorithm 70 may be configured to determine the debt trend segment 72 based solely based on internal financial institution debt or, in other embodiments, the debt trend algorithm may determine the debt trend segment based on both internal financial institution debt and external financial institution debt. In one specific embodiment of the debt trend segment 72 may include one of five segments, specifically, increasing, decreasing, stable, zero and missing. The increasing debt segment indicates that the customer's debt has increased over a predetermined time period; the decreasing debt segment indicates that the customer's debt has decreased over the predetermined time period; and the stable debt indicates that the customer's debt has remained stable or relatively stable over the predetermined period. Further, the zero debt segment indicates that the customer has a credit account but no debt and the missing debt segment indicates that the customer has no credit accounts. FIG. 8, discussed infra. provides further details related to the process for determining debt trend.

Wallet share behavior routine 80 leverages internal financial institution customer behavior data and external financial institution customer behavior data to determine, for each of the plurality of financial institution customers, the debt wallet share attributable to the internal financial institution. the wallet share behavior routine is configured to determine the wallet share behavior segment 82, such that, the wallet share segment is one of zero wallet share, between zero and twenty-five percent wallet share, between twenty-five percent and fifty percent wallet share, between fifty percent and seventy-five percent wallet share, between seventy-five and one hundred percent wallet share, and missing.

Profitability behavior algorithm 90 is configured to determine, for the plurality of financial institution customers, a profitability segment 92 that indicates the customer's profitability. The profitability behavior algorithm 90 may be configured to determine the profitability segment 82 financial institution-wide (i.e., all accounts or products associated with the customer) or, in other embodiments, the profitability behavior algorithm 90 may determine the profitability segment 92 based on one or more specific accounts/products, such as a credit card account or the like. In one specific embodiment of the profitability segment 92 may include one of three segments, specifically, most profitable, intermediate profitable and negative profitable. The most profitable segment indicates that the customer meets or exceeds a financial institution profitability measurement for inclusion in the most profitable grouping; the intermediate profitability segment indicates that the customer's financial institution profitability is less than the most profitable threshold and greater than zero; and the negative profitable segment indicates that the financial institution is unprofitable for this particular customer.

Rewards behavior algorithm 100 is configured to determine, for the plurality of financial institution customers, one or more rewards segments 102 that indicate the customer's rewards behavior, in those instances in which the financial institution implements a rewards program or the like. Rewards segment 102 may indicate the customer's reward preference (e.g., cash-back, airlines miles, etc.), frequency of rewards redemption, average redemption amount or the like.

Risk behavior algorithm 110 is configured to determine, for the plurality of financial institution customers, a risk segment 112 that indicates the customer's risk to the financial institution, for, example, the likelihood that the customer will commit an actionable offense on the financial institution or some other risk-related activity. The risk behavior algorithm 110 may be configured to determine the risk segment 112 based solely based on internal financial institution account activity or, in other embodiments, the risk behavior algorithm 110 may determine the risk segment 112 based on both internal financial institution account activity and external financial institution account activity.

Market share behavior routine 120 leverages financial institution customer behavior data and external financial institution customer behavior data to determine, for each of the plurality of financial institution customers, one or more market share segments 122 for the internal financial institution, such as the credit card market share attributable to the financial institution or the like.

The legacy segmentation interface algorithm 130 may be configured to provide an interface to other legacy or other financial institution segmentation applications. The interface algorithm 130 may provides for legacy behavior segments 132 based on behaviors determined by the legacy or other financial institution segmentation applications/systems. In this regard, the customer segmentation application 18 provides the ability to work in tandem with existing segmentation applications/systems.

The other behavior algorithm 140 accounts for any other behavior algorithm that may be added to the customer segmentation application 18 based on financial institution need. The customer segmentation application 18 is a highly configurable application that provides for ease in the user's ability to add additional behavior algorithms in the future. In this regard, the customer segmentation application 18 is expandable to adapt to new business needs.

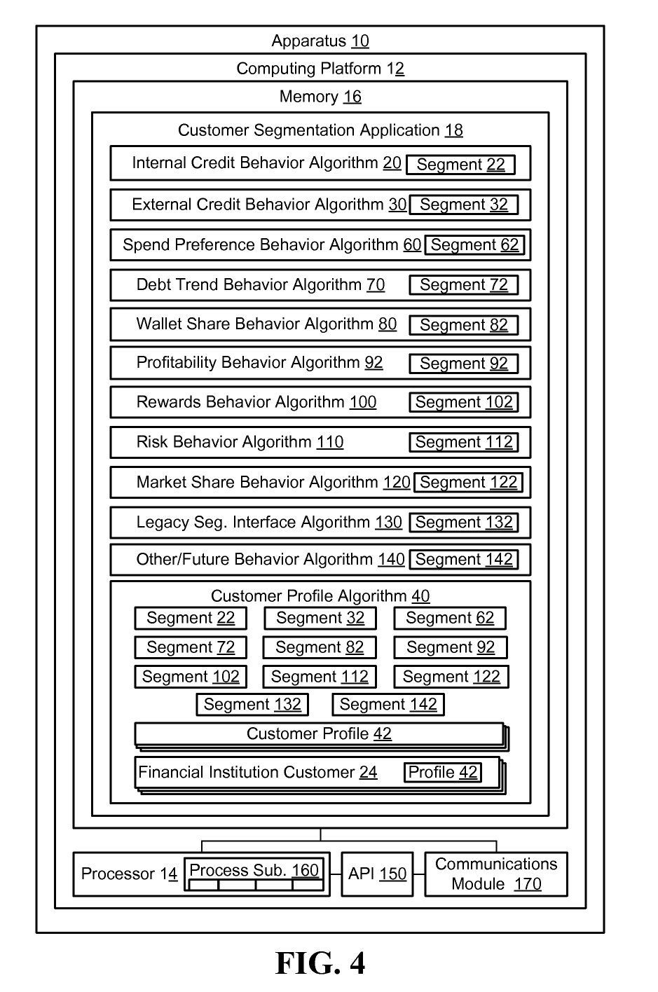

Referring to FIG. 4, shown is a more detailed block diagram of apparatus 10, according to embodiments of the present invention. The apparatus 10 is a comprehensive holistic view of customer behaviors and provide for determining customer profiles and/or customer segments based on any combination of customer behaviors. In addition to providing greater detail, FIG. 3 highlights various alternate embodiments of the invention. The apparatus 10 may include one or more of any type of computerized device. The present apparatus and methods can accordingly be performed on any form of one or more computing devices.

The apparatus 10 includes computing platform 12 that can receive and execute algorithms, such as routines, and applications. Computing platform 12 includes memory 16, which may comprise volatile and non-volatile memory, such as read-only and/or random-access memory (RAM and ROM), EPROM, EEPROM, flash cards, or any memory common to computer platforms. Further, memory 16 may include one or more flash memory cells, or may be any secondary or tertiary storage device, such as magnetic media, optical media, tape, or soft or hard disk.

Further, computing platform 12 also includes processor 14, which may be an application-specific integrated circuit (“ASIC”), or other chipset, processor, logic circuit, or other data processing device. Processor 14 or other processor such as ASIC may execute an application programming interface (“API”) 150 that interfaces with any resident programs, such as customer segmentation application 18 and algorithms associated therewith or the like stored in the memory 16 of the apparatus 10.

Processor 14 includes various processing subsystems 160 embodied in hardware, firmware, software, and combinations thereof, that enable the functionality of apparatus 10 and the operability of the apparatus on a network. For example, processing subsystems 160 allow for initiating and maintaining communications and exchanging data with other networked devices. For the disclosed aspects, processing subsystems 160 of processor 14 may include any subsystem used in conjunction with customer segmentation application 18 and related algorithms, sub-algorithms, sub-modules thereof.

Computer platform 12 additionally includes communications module 170 embodied in hardware, firmware, software, and combinations thereof, that enables communications among the various components of the apparatus 10, as well as between the other networked devices. Thus, communication module 170 may include the requisite hardware, firmware, software and/or combinations thereof for establishing a network communication connection and communicating customer profiles 42, customer segments 52 or reports included the profiles and/or segments to financial institution entities.

As previously noted, the memory 16 of apparatus 10 stores customer segmentation application 18 that is configured to determine financial institution customer profiles and/or customer segments based on any combination of customer behavior segments determined by behavior algorithms 20, 30, 60, 70, 80, 90, 100, 110, 120, 130 and 140, in accordance with embodiments of the present invention. The customer segmentation application 18 may be embodied in advanced analytics software or the like.

Additionally, as previously noted, customer segmentation application 18 includes internal credit behavior algorithm 20 that is configured to determine, for a plurality of financial institution customers 24, an internal credit behavior segment 22 that is associated with one or more internal credit accounts. The internal credit behavior segment 22 may be any one of a plurality of user defined segments that classify the customer according to their internal credit behavior.

Customer segmentation application 18 additionally includes external credit behavior algorithm 30 that is configured to determine, for a plurality of financial institution customers 24, an external credit behavior segment 32 that is associated with one or more external financial institutions and one or more credit accounts at each of the financial institutions. The external credit behavior segment 32 may be any one of a plurality of user defined segments that classify the customer according to their external credit behavior.

Additionally, customer segmentation application 18 may include spending preference behavior algorithm 60 that is configured to determine, for a plurality of financial institution customers 24, a spending preference segment 62. The spending preference segment 62 may be any one of a plurality of user defined segments that classifies the customer according to their preferred payment type, such as a financial account or financial product.

Customer segmentation application 18 may also include debt trend behavior algorithm 70 that is configured to determine, for the plurality of financial institution customers, a debt trend segment 72 that indicates the trend status of the customer's debt. Additionally, application 18 may include wallet share behavior routine 80 that is configured to determine the wallet share behavior segment 82, such that, the wallet share segment indicates the debt wallet share attributable to the internal financial institution.

The application 18 may additionally include profitability behavior algorithm 90 that is configured to determine, for the plurality of financial institution customers, a profitability segment 92 that indicates the customer's profitability; financial institution-wide profitability and/or product/account-based profitability. In addition, customer segmentation application 18 may include rewards behavior algorithm 100 that is configured to determine, for the plurality of financial institution customers, one or more rewards segments 102 that indicate the customer's rewards behavior, such as, the customer's reward preference, frequency of rewards redemption, average redemption amount or the like.

In additional embodiments, customer segmentation application 18 may include risk behavior algorithm 110 that is configured to determine, for the plurality of financial institution customers, a risk segment 112 that indicates the customer's risk to the financial institution, for, example, the likelihood that the customer will commit an actionable offense against the financial institution or some other risk-related activity. In other embodiments, application 18 may include market share behavior routine 120 that is configured to determine, for each of the plurality of financial institution customers, one or more market share segments 122 for the internal financial institution, such as the credit card market share attributable to the financial institution or the like.

Additionally, the customer segmentation application 18 may include legacy segmentation interface algorithm 130 that is configured to provide an interface to other legacy or other financial institution segmentation applications. The interface algorithm 110 may provides for legacy behavior segments 132 based on behaviors determined by the legacy or other financial institution segmentation applications/systems.

Moreover, customer segmentation application 18 provides for other behavior algorithm(s) 140 that may be added to the customer segmentation application 18 based on financial institution need. As such, the customer segmentation application 18 is a highly configurable application that provides for ease in the user's ability to add additional behavior algorithms in the future.

Customer segmentation application 18 additionally includes customer profile algorithm 40 that is configured to determine a customer profile 42 for each of the plurality of customers based on any combination of the behavior algorithms previously mentioned and/or additional behavior algorithms that may be subsequently provided for in the application 18.

Additionally, customer segmentation application 18 may include customer segment algorithm 50 that is configured to determine a customer segment 52 for each of the plurality of customers based one or more behavior segments 22, 32, 62, 72, 82, 92, 102, 112 or 122 determined by associated behavior algorithms 20, 30, 60, 70, 80, 90, 100, 110 or 120. In one specific embodiment of the invention, in which the behavior segments implemented include internal credit behavior segment 22, external behavior credit segment 32 and spend preference segment 62, twelve customer profiles are defined. The customer profiles are defined based on key metrics, such as, but not limited to, purchasing activity, balances over time, credit losses, account activation rates or the like. Similar customer populations are grouped alike to result in the twelve customer 42 profiles.

The twelve customer profiles include (1) core financial institution customer profile, which includes customers indexing high for balance and usage across most, if not all, major consumer financial institution products; (2) pay another day profile, which includes customers with revolving credit balances internally and externally and which have a credit card as the preferred payment type; (3) loan-centric profile, which includes customers with high credit card balances and low credit card retail activity; (4) room-to-grow profile, which includes customers with either no relationship or inactive relationships; (5) focused user profile, which includes customers with high card retail spend, which is most likely for convenience and/or rewards; (6) cash/debit-is-king profile, where the customers may or may not have a credit card account but do not use it or other credit accounts, and rather almost exclusively rely on deposit accounts for payments; (7) a potential revolver profile, in which customers have external revolving credit and may therefore do so internally in the future; (8) a potential transactor profile, in which customers have external transacting credit and may therefore do so internally in the future; (9) a everything-but-credit profile, where customers maintain a strong relationship with the internal financial institution but have no credit activity internally or externally; (10) a bank-here-borrow-there profile, where customers maintain a strong relationship with the internal financial institution and have revolving behavior externally; (11) a checks-and-balances profile, in which customers have high check spend and high deposit balances; and (12) a conscientious spender profile, where customers have high spend overall but the spend is in categories where the transaction is not face-to-face (e.g. check, bill pay, ACH, etc.).

Referring to FIG. 5 a flow diagram is depicted of a method 400 for determining internal credit behavior segments, in accordance with embodiments of the present invention. It should be noted that the method detailed in FIG. 5 is by way of example only and other methods for internal credit segmentation and determining segmentation can be employed without departing from the inventive concepts herein disclosed. The method provides a hierarchical approach to internal credit behavior segmentation. At Decision 402 a determination is made as to whether the customer has any internal credit account with a revolving balance (i.e., a credit account in which the balance is carried over month-to-month and interest accrues. If the customer has an internal credit account with a revolving balance, at Event 404, the customer is assigned to the revolver segment for internal credit behavior.

If the customer does not have any internal credit accounts with revolving credit, at Decision 406 a determination is made as to whether the customer has any internal credit accounts with a transacting balance (i.e., a credit account in which the customer pays the balance in full each payment period). If the customer has an internal credit account with transacting balance, at Event 408, the customer is assigned the transactor segment for internal credit behavior. If the customer does not have an internal credit account with a transacting balance, at Decision 410, a determination is made as whether the customer has any internal credit account. If the determination is made that the customer does have an internal credit account, at Event 412, the customer is assigned to the inactive segment for internal credit behavior, which indicates that the customer is currently not using the credit accounts If the determination is made that the customer does not have an internal credit account, at Event 414, the customer is assigned to the missing segment for internal credit behavior, which indicates that the customer does not have an internal credit account.

Referring to FIG. 6 a flow diagram is depicted of a method 500 for determining external credit behavior segments, in accordance with embodiments of the present invention. It should be noted that the method detailed in FIG. 6 is by way of example only and other methods for external credit segmentation and determining segmentation can be employed without departing from the inventive concepts herein disclosed. The method provides a hierarchical approach to external credit behavior segmentation. At Decision 502 a determination is made as to whether the customer has any external credit account with a revolving balance (i.e., an external credit account in which the balance is carried over month-to-month and interest accrues. If the customer has an external credit account with a revolving balance, at Event 504, the customer is assigned to the revolver segment for external credit behavior.

If the customer does not have any external credit accounts with revolving credit, at Decision 506 a determination is made as to whether the customer has any external credit accounts with a transacting balance (i.e., an external credit account in which the customer pays the balance in full each payment period). If the customer has an external credit account with transacting balance, at Event 508, the customer is assigned the transactor segment for external credit behavior. If the customer does not have an external credit account with a transacting balance at Decision 510, a determination is made as whether the customer has any external credit account. If the determination is made that the customer does have an external credit account, at Event 512, the customer is assigned to the inactive segment for external credit behavior, which indicates that the customer is currently not using the external credit accounts If the determination is made that the customer does not have an external credit account, at Event 414, the customer is assigned to the missing segment for external credit behavior, which indicates that the customer does not have an external credit account.

Referring to FIG. 7 a flow diagram is depicted of a method 600 for determining spend preference segments, in accordance with embodiments of the present invention. It should be noted that the method detailed in FIG. 7 is by way of example only and other methods for of spend preference segmentation and determining segmentation can be employed without departing from the inventive concepts herein disclosed. The method may be limited to internal financial institution spend preference or, in other embodiments, pertain to both internal and external spend preference. At Event 602, a first payment type having the highest volume of transactions over a predetermined time period (e.g., a month) is determined. The payment type may include, but is not limited to, credit card, debit card, checks, cash (ATM), online/mobile bill pay, missing and the like.

At Event 604, a second payment type having the highest overall transaction amount over the predetermined time period (e.g., a month) is determined. At Decision 606, a determination is made as to whether the first and second payment types are the same payment types (i.e., the same payment type has both the highest number of transactions and the highest overall transaction amount). If the first and second payment types are the same payment types, at Event 608, the customer is assigned to the associated payment type segment as the spend preference behavior. If the first and second payment types are different payment types, at Event 610, the customer is assigned to the mixed value segment as the spend preference behavior, which indicates different payment types for highest volume of transactions and highest overall transaction amount.

Referring to FIG. 8 a flow diagram is depicted of a method 700 for determining debt trend segments, in accordance with embodiments of the present invention. It should be noted that the method detailed in FIG. 8 is by way of example only and other methods for of debt trend segmentation and determining segmentation can be employed without departing from the inventive concepts herein disclosed. In specific embodiments of the invention debt trend segmentation may take into account both internal and external debt, while in other embodiments, the debt trend may be limited to internal or external debt. At Decision 702 a determination is made as to whether the customer's debt has increased, by any amount, a predetermined amount or a predetermined percentage, over a predetermined time period (e.g., a month, three months, six months, a year or the like). If the customer's debt has been determined to have increased, at Event 704, the customer is assigned to the increasing debt segment as the debt trend behavior.

At Decision 706, a determination is made as to whether the customer's debt has decreased, by any amount, a predetermined amount or a predetermined percentage, over the predetermined time period. If the customer's debt has been determined to have decreased, at Event 708, the customer is assigned to the decreasing debt segment as the debt trend behavior. At Decision 710, a determination is made as to whether the customer's debt has remained stable over the predetermined time period. Stable may be defined as no change since the prior predetermined time period, or change within a limited predetermined amount or change within a predetermine limited percentage. If the customer's debt has been determined to have been stable, at Event 712, the customer is assigned to the stable debt segment as the debt trend behavior. At Decision 714, a determination is made as to whether the customer has an account with no debt outstanding. If the determination is made that the customer has an account but no debt outstanding, at Event 716, the customer is assigned to the zero segment. If a determination is that the customer has no credit account then, at Event 718, the customer is assigned to the missing debt segment.

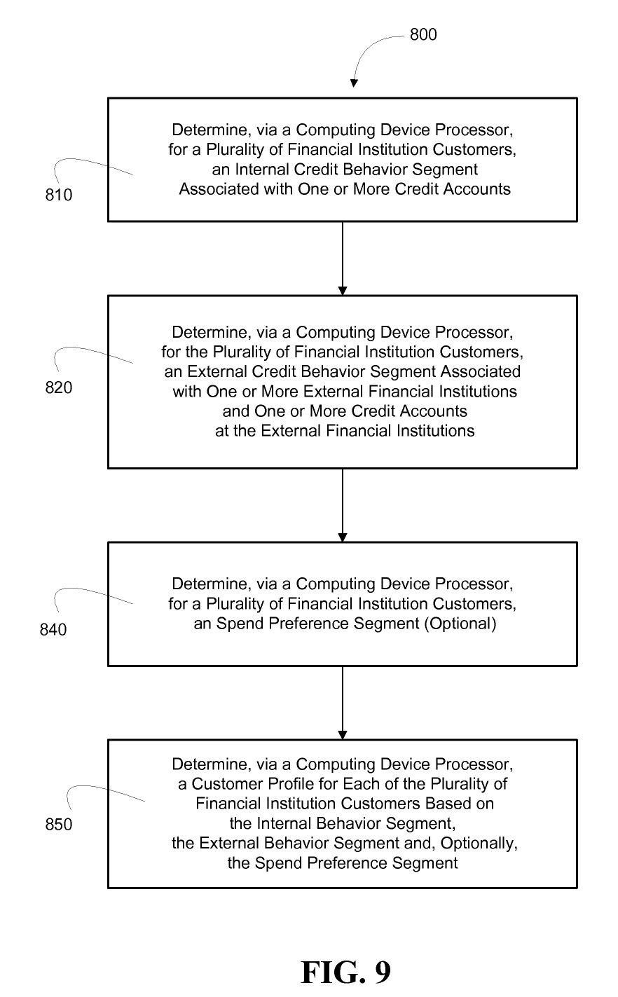

Turning the reader's attention to FIG. 9 a flow diagram is depicted of a method 800 for determining behavior-based customer segments and customer profiles based on the segments, in accordance with embodiments of the present invention. At Event 810, an internal credit behavior segment that is associated with one or more internal credit accounts is determined for a plurality of financial institution customers. At Event 820, an external credit behavior segment that is associated with one or more external financial institutions and one or more credit accounts at the external financial institutions is determined for the plurality of financial institution customers.

In specific embodiment of the method the internal credit behavior segment and the external credit behavior segment may be a predefined predominate credit behavior from amongst the one or more credit accounts at the internal financial institution an at the one or more external financial institutions, respectively. In one specific embodiment, the internal credit behavior segment and the external credit behavior segment may be one of revolver segment, transactor segment, inactive segment or missing segment. In such specific embodiment, the assignment of the segments may be (1) revolver segment if a revolving balance exists across any of the one or more credit internal/external accounts, (2) transactor segment if revolving balance does not exist across any of the one or more internal/external credit accounts and one or more of the internal/external accounts is active (i.e., the customer pays the balance in full at each predetermined payment period), (3) inactive segment if not assigned to revolver segment or transactor segment (i.e., no credit accounts are active) or (4) missing segment if no customer account exists.

At optional Event 830, a spend preference segment is determined for the plurality of financial institution customers. The spend preference may indicate the customer's payment type preference in terms of the highest volume of transactions occurring with a payment type and/or the highest overall transaction amount occurring with a payment type.

At Event 840, a customer profile is determined for each of the plurality of financial institution customers based on the internal credit segment, the external credit segment and, optionally, the spend preference segment. In optional embodiments of the method, additional behavior-based segments may be determined such as, but not limited to, debt trend, profitability, risk, rewards or the like and may be used in combination with the other segments in determining an appropriate customer profile.

Thus, present embodiments herein disclosed provide for comprehensive behavior-based customer segmentation and resulting customer profiling based on the segmentation. The embodiments disclosed provide for any combination of behavior-based segmentation algorithms to be implemented to render a customer profile. The segmentation algorithms include, but are not limited to, internal credit behavior, external credit behavior, spend preference behavior, debt trend behavior, risk behavior, rewards behavior, profitability behavior and the like. In addition, embodiment provide for the segmentation platform to be expandable to allow for additional segments to be identified based on additional customer behaviors. Moreover, embodiments provide for the ability of the segmentation application to interface with pre-existing segmentation applications.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. An apparatus for characterization of a plurality of financial institution customers, the apparatus comprising:
a computing device including a memory and at least one processor; and
a customer segmentation application stored in the memory, executable by the processor, configured to determine customer segments based on customer behaviors and customer characterizations based on the segments and including:
an internal credit behavior algorithm configured to determine, for each of a plurality of financial institution customers, an internal credit behavior segment associated with one or more internal credit accounts that are internal to a financial institution implementing the customer segmentation application, wherein the internal credit behavior segment defines a customer's preference to (a) carry a credit balance from one payment period to a next payment period in one or more of the internal credit accounts, (b) pay off all internal credit accounts in full each payment period, or (c) currently not have any active internal credit accounts,
an external credit behavior algorithm configured to determine, for each of a plurality of financial institution customers, an external credit behavior segment associated with one or more external financial institutions that are external to the financial institution implementing the customer segmentation application and one or more credit accounts at the one or more external financial institutions, wherein the external credit behavior segment defines a customer's preference (a) carry a credit balance from one payment period to a next payment period in one or more of the external credit accounts, (b) pay off all external credit accounts in full each payment period, or (c) currently not have any active external credit accounts,
a spend preference behavior algorithm configured to determine, for each of a plurality of financial institution customers, a spend preference behavior segment that is defined by a customer's preferred payment type, wherein the preferred payment type is defined as a payment account which the customer prefers using for payment transactions, and
a customer characterization algorithm configured to determine a customer characterization for each of the plurality of financial institution customers based on the internal credit behavior segment, the external credit behavior segment and the spend preference behavior segment.

2. The apparatus of claim 1, wherein the spend preference behavior algorithm is further configured to determine a first payment type having a highest volume of transactions over a predetermined time period and determine a second payment type having a highest transaction amount over the predetermined time period.

3. The apparatus of claim 2, wherein the spend preference behavior algorithm is further configured to assign the spend preference behavior segment to a payment type segment if the first and second payment types are a same payment type.

4. The apparatus of claim 3, wherein the spend preference behavior algorithm is further configured to assign the spend preference behavior segment to a mixed value segment if the first and second payment types are different payment types, wherein the mixed value segment is defined by the first and second payment types being different payment types.

5. The apparatus of claim 1, wherein the customer segmentation application further comprises a debt trend behavior algorithm configured to determine, for each of a plurality of financial institution customers, a debt trend behavior segment that defines a customer's current debt status and wherein the customer characterization algorithm is further configured to determine the customer characterization based on the debt trend segment.

6. The apparatus of claim 5, wherein the debt trend behavior algorithm is further configured to determine the debt trend behavior segment, wherein debt trend is combined internal-financial institution and external-financial institution debt trend, wherein internal-financial institution debt trend is associated with the customer's current debt trend internal to a financial institution implementing the customer segmentation application and external-financial institution debt trend is associated with the customer's current debt trend at one or more external financial institutions that are external to the financial institution implementing the customer segmentation application.

7. The apparatus of claim 5, wherein the debt trend behavior algorithm is further configured to determine the debt trend behavior segment, wherein the debt trend segment is one of increasing debt, decreasing debt, stable debt or missing debt.

8. The apparatus of claim 1, wherein the customer segmentation application further comprises a profitability behavior algorithm configured to determine, for each of a plurality of financial institution customers, a profitability behavior segment, associated with one or more financial accounts or financial services, that defines a customer's profitability to the financial institution and wherein the customer characterization algorithm is further configured to determine the customer characterization based on the internal credit behavior segment, the external credit behavior segment and the profitability behavior segment.

9. The apparatus of claim 1, wherein the customer segmentation application further comprises a rewards behavior segment configured to determine, for each of a plurality of financial institution customers, a rewards behavior segment associated with one or more financial accounts or financial services, that defines a customer's rewards tendencies and wherein the customer characterization algorithm is further configured to determine the customer characterization based on the rewards behavior segment.

10. The apparatus of claim 9, wherein the rewards behavior algorithm is further configured to determine the rewards behavior segment associated with one of rewards preferences, frequency of rewards or average redemption amounts.

11. The apparatus of claim 1, wherein the customer segmentation application further comprises a risk behavior algorithm configured to determine, for each of a plurality of financial institution customers, a risk behavior segment that defines a customer's risk posed to the financial institution and wherein the customer characterization algorithm is further configured to determine the customer characterization based on the risk behavior segment.

12. An apparatus for characterization of a plurality of financial institution customers, the apparatus comprising:
a computing device including a memory and at least one processor; and
a customer segmentation application stored in the memory, executable by the processor, configured to determine customer segments based on customer behaviors and customer characterizations based on the segments and including:
an internal credit behavior algorithm configured to determine, for each of a plurality of financial institution customers, an internal credit behavior segment associated with one or more internal credit accounts that are internal to a financial institution implementing the customer segmentation application, wherein the internal credit behavior segment defines a customer's preference to (a) carry a credit balance from one payment period to a next payment period in one or more of the internal credit accounts, (b) pay off all internal credit accounts in full each payment period, or (c) currently not have any active internal credit accounts,
an external credit behavior algorithm configured to determine, for each of a plurality of financial institution customers, an external credit behavior segment associated with one or more external financial institutions that are external to the financial institution implementing the customer segmentation application and one or more credit accounts at the one or more external financial institutions, wherein the external credit behavior segment defines a customer's preference (a) carry a credit balance from one payment period to a next payment period in one or more of the external credit accounts, (b) pay off all external credit accounts in full each payment period, or (c) currently not have any active external credit accounts,
a spend preference behavior algorithm configured to determine, for each of a plurality of financial institution customers, a spend preference behavior segment that is defined by a customer's preferred payment type, wherein the preferred payment type is defined as a payment account which the customer prefers using for payment transactions,
a debt trend behavior algorithm configured to determine, for each of a plurality of financial institution customers, a debt trend behavior segment that defines a customer's current debt status and wherein the customer characterization algorithm is further configured to determine the customer characterization based on the debt trend segment,
a profitability behavior algorithm configured to determine, for each of a plurality of financial institution customers, a profitability behavior segment, associated with one or more financial accounts or financial services, that defines a customer's profitability to the financial institution and wherein the customer characterization algorithm is further configured to determine the customer characterization based on the internal credit behavior segment, the external credit behavior segment and the profitability behavior segment,
a rewards behavior segment configured to determine, for each of a plurality of financial institution customers, a rewards behavior segment associated with one or more financial accounts or financial services, that defines a customer's rewards tendencies and wherein the customer characterization algorithm is further configured to determine the customer characterization based on the rewards behavior segment, and
a customer characterization algorithm configured to determine a customer characterization for each of the plurality of financial institution customers based on the internal credit behavior segment, the external credit behavior segment, the spend preference behavior segment, the debt trend behavior segment, the profitability behavior segment, and the rewards behavior segment.

13. A computer program product comprising:
a non-transitory computer-readable medium encoded with instructions when executed by a processor perform the steps of:
determining, for a plurality of financial institution customers, an internal credit behavior segment associated with one or more credit accounts that are internal to a financial institution segmenting customers, wherein the internal credit behavior segment defines a customer's preference to (a) carry a credit balance from one payment period to a next payment period in one or more of the internal credit accounts, (b) pay off all internal credit accounts in full each payment period, or (c) currently not have any active internal credit accounts;
determining, for the plurality of financial institution customers, an external credit behavior segment associated with one or more external financial institutions that are external to the financial institution segmenting customers and one or more credit accounts at the one or more external financial institutions, wherein the external credit behavior segment defines a customer's preference (a) carry a credit balance from one payment period to a next payment period in one or more of the external credit accounts, (b) pay off all external credit accounts in full each payment period, or (c) currently not have any active external credit accounts;
determining, via a computing device processor, for the plurality of financial institution customers, a spend preference behavior segment that defines a customer's preferred payment type, wherein the preferred payment type is defined as a payment account which the customer prefers using for payment transactions; and
determining a customer characterization for each of the plurality of financial institution customers based on the internal credit behavior segment, the external credit behavior segment and the spend preference behavior segment.

14. The computer program product of claim 13, wherein the step of determining the spend preference further comprises determining a first payment type having a highest volume of transactions over a predetermined time period and determining a second payment type having a highest transaction amount over the predetermined time period.

15. The computer program product of claim 14, wherein the step of determining the spend preference further comprises assigning the spend preference behavior segment to a payment type segment if the first and second financial accounts are determined to be same payment type or assigning the spend preference behavior segment to a mixed value segment if the first and second payment types are determined to be different payment types, wherein the mixed value segment is defined by the first and second payment types being different payment types.

16. The computer program product of claim 13, wherein the instructions when executed by the processor further perform the step of determining, for the plurality of financial institution customers, a debt trend behavior segment that defines a customer's current debt status and wherein the step of determining the customer characterization further comprises determining the customer characterization for each of the plurality of financial institution customers based on the debt trend segment.

17. The computer program product of claim 16, wherein the step of determining the debt trend further comprises determining the debt trend behavior segment, wherein the debt trend segment is one of increasing debt trend, decreasing debt trend or stable debt trend.

18. The computer program product of claim 13, wherein the instructions when executed by the processor further perform the step of determining, for the plurality of financial institution customers, a profitability behavior segment, associated with one or more financial accounts or financial services, that defines a customer's profitability to the financial institution and wherein the step of determining the customer characterization further comprises determining, a customer characterization for each of the plurality of financial institution customers based on the profitability behavior segment.

19. The computer program product of claim 13, wherein the instructions when executed by the processor further perform the step of determining, for the plurality of financial institution customers, a rewards behavior segment, associated with one or more financial accounts or financial services, that defines a customer's rewards tendencies and wherein the step of determining the customer characterization further comprises determining the customer characterization for each of the plurality of financial institution customers based on the rewards behavior segment.

20. The computer program product of claim 13, wherein the instructions when executed by the processor further perform the step of determining, for the plurality of financial institution customers, a risk behavior segment, associated with a financial institution customer, that defines a customer's risk posed to the financial institution and wherein the step of determining the customer characterization further comprises determining the customer characterization for each of the plurality of financial institution customers based on the internal credit behavior segment, the external credit behavior segment and the risk behavior segment.
